(19) United States
(12) Patent Application Publication
(10) Pub. No.: US 2015/0044953 A1
(43) Pub. Date: Feb. 12, 2015

(54) Processing Shrimp with Hydrodynamic Turbulence and Hydrostatic Pressure

(71) Applicant: Laitram, L.L.C., Harahan, LA (US)

(72) Inventor: James M. Lapeyre, III, New Orleans, LA (US)

(21) Appl. No.: 14/453,184

(22) Filed: Aug. 6, 2014

Related U.S. Application Data
(60) Provisional application No. 61/862,550, filed on Aug. 6, 2013.

(51) Int. Cl. A22C 29/02

(52) U.S. Cl. CPC A22C 29/024; A22C 29/028
USPC 452/4

(57) ABSTRACT

Method and system for processing shrimp using hydrodynamic turbulence and hydrostatic pressure to peel shrimp. The system uses hydraulics to remove the heads, shells, and appendages from shrimp. Heads are detached in a hydraulic head detacher that uses one or more venturis to subject the shrimp to a turbulent hydrodynamic flow. The shells and appendages of headless shrimp are loosened in a high-pressure hydraulic press that subjects the headless shrimp to a high hydrostatic pressure. The loosened shell and appendages are detached from the headless shrimp in a hydraulic shell detacher similar to the head detacher to produce peeled shrimp meats. Shrimp meats with residual shell or appendages are separated from the completely peeled shrimp meats.

### CROSS-REFERENCE TO RELATED APPLICATIONS

This application claims priority to U.S. Provisional Patent Application No. 61/862,550, filed Aug. 6, 2013, and incorporated entirely by reference into this specification.

### BACKGROUND

The invention relates generally to shellfish processing and more particularly to systems and methods for removing the heads and shells from shrimp by using hydraulics.

Deheading shrimp by subjecting them to hydrodynamic forces is known from U.S. Pat. No. 5,195,921, “Apparatus for Deheading and Cleansing Shrimp,” issued Mar. 23, 1993. Removing the shell of lobsters, crabs, and shrimp by subjecting them to hydrostatic pressure is known from U.S. Pat. No. 7,871,314, “Method for Shucking Lobster, Crab, or Shrimp,” issued Jan. 18, 2011. The apparatus of the U.S. Pat. No. 5,195,921 patent is designed to remove heads only. And some of the shrimp processed according to the method of the U.S. Pat. No. 7,871,314 patent can have residual shell and appendages clinging to the shrimp bodies.

### SUMMARY

One version of a system embodying features of the invention for processing shrimp comprises a hydraulic head detacher that accelerates the flow of a shrimp-laden fluid to subject the shrimp to turbulence that detaches heads from the bodies of the shrimp. A pressure chamber receives the headless shrimp bodies from the hydraulic head detacher and subjects the headless shrimp bodies to a high hydrostatic pressure for a predetermined dwell time. The pressure is high enough and the dwell time long enough to loosen the shells of the headless shrimp bodies without damaging the shrimp bodies.

According to another aspect of the invention, a method for processing shrimp comprises: (a) accelerating a flow of shrimp-laden fluid to subject the shrimp to turbulence that detaches heads from the bodies of the shrimp; (b) subjecting the headless shrimp bodies to a hydrostatic pressure high enough for a dwell time long enough to loosen the shells from the headless shrimp bodies without damaging the shrimp bodies.

### BRIEF DESCRIPTION OF THE DRAWINGS

The invention is described in more detail in the following description, appended claims, and accompanying drawings, in which:

FIG. 1 is a block diagram of a shrimp-processing system embodying features of the invention; and

FIG. 2 is an isometric view of a hydraulic shrimp or shell detacher usable in the shrimp-processing system of FIG. 1.

### DETAILED DESCRIPTION

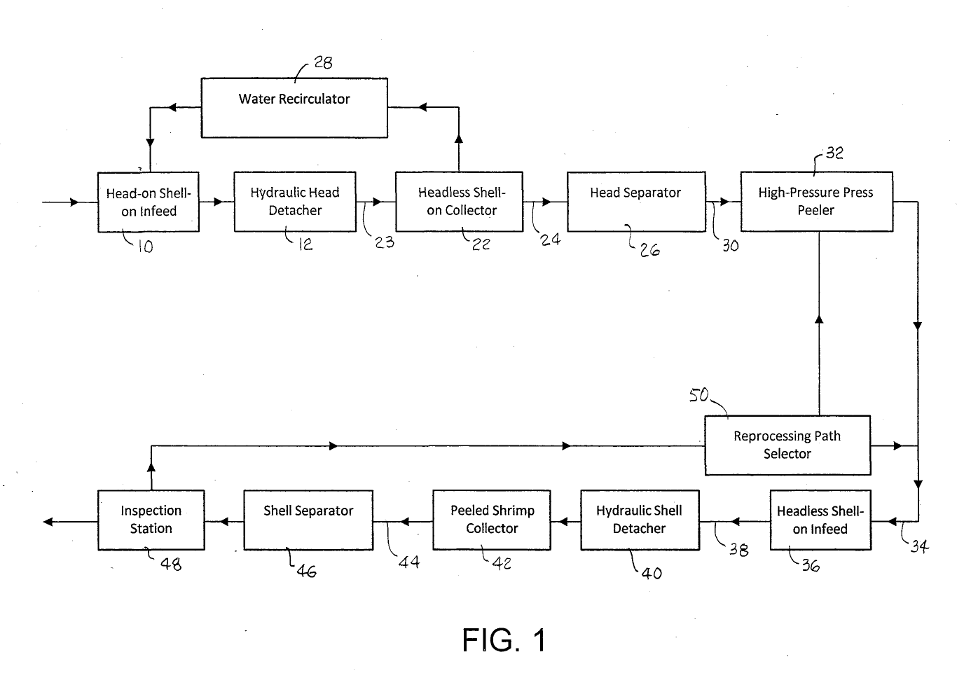

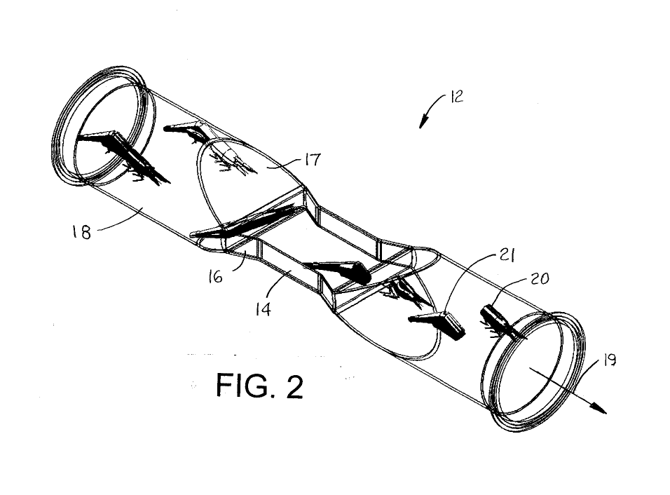

One version of a shrimp-processing system embodying features of the invention is shown in FIG. 1. An infeed system 10 feeds raw head-on, shell-on shrimp to a hydraulic head detacher 12. The infeed system includes, for example, a feed tank into which shrimp are conveyed, a food pump, and a conduit through which the food pump pumps a shrimp-laden fluid, such as water, in a continuous flow. The hydraulic head detacher 12 comprises a single channel restriction or a cascade of restrictions in the conduit that accelerate the flow, producing a velocity gradient along the length of the detacher. The acceleration can be abrupt or gradual depending on the abrupt or gradual nature of the restriction. FIG. 2 shows a hydraulic detacher 12 with a restriction 14 that has a gradual acceleration effect because of the gradual tapered regions 16, 17 leading from the wider conduit 18 into the restriction in the direction of flow 19. Shorter tapered regions at sharper taper angles produce more abrupt accelerations. The acceleration of the flow, which is due to the venturi effect, causes turbulence immediately downstream of the restricted region 14 that detaches the loosely connected heads 20 from the shrimp bodies 21. As already mentioned, a series of venturi detachers, or venturis, as in FIG. 2 may be connected in cascade to increase the percentage of shrimp with heads detached.

The detached heads 20 flow to a collector 22 that collects the headless shrimp bodies and the detached heads conveyed through connecting conduit 23 from the head detacher 12. One example of a collector includes a fluid removal screen through which the fluid drains to a reservoir, a collection tank into which the detached heads and headless bodies drop, and a conveyor 24 that transports the heads and bodies to a head separator 26.

An optional water recirculator 28, which can include filters or other water treatment components, a pump, and inlet valves to admit fresh water to replenish lost fluid, recirculates the filtered spent fluid back into the flow at the front end of the head detacher 12.

At the head separator 26, which can be an air separator or a manual inspection station, the headless shrimp bodies are culled from the detached heads. A conveyor 30, such as a belt conveyor or a flume, transports the headless shrimp bodies to a high-pressure press 32, such as a hydraulic food press manufactured by Avure Technologies, Inc. The high-pressure press 32 has a sealable pressure chamber into which the headless shrimp are deposited in batches directly by the conveyor 30 or by a robotic loader. The chamber is sealed and fluid is pumped in to pressurize the chamber to a predetermined high pressure level for a predetermined dwell time. The pressure level is high enough and the dwell time long enough to loosen the shells and appendages from their attachment to the shrimp bodies without damaging the shrimp bodies. Once the shrimp have been subjected to the elevated hydrostatic pressure for the predetermined dwell time, the batch of headless shrimp is removed from the open chamber by a conveyor or robotic extractor and transported by a conveyor 34 to a second infeed system 36.

Like the first infeed system 10, the second infeed system can include a feed tank, in which the headless shrimp with loosened shell and appendages are accumulated, a food pump for entraining the shrimp in a fluid flow through a conduit 38 leading to another hydraulic detacher 40 that is used to detach the loosened shell and appendages from the headless shrimp bodies. The hydraulic shell detacher 40 is similar to the hydraulic head detacher 12. The number of venturi restrictions, their velocity gradients, and their flow rates can all be tailored to detach loosened shell and appendages without damaging the peeled shrimp meat.

The peeled shrimp are collected in a peeled shrimp collector 42. Like the headless, shell-on collector 22 after the hydraulic head detacher 12, the peeled shrimp collector 42 can include a water removal screen, a collection tank, and an outfeed conveyor 44. A water recirculator (not shown) may be used with the shell detacher and separator. The peeled shrimp collector drains the water from the shrimp meat and the detached shell and appendages. The outfeed conveyor 44 delivers the shrimp meat, detached shell, and appendages to a shell separator 46, which includes one or more cleaners or roller separators interconnected by conveyors or flumes. The shell separator separates the detached shell and appendages from the peeled shrimps, which are conveyed to an inspection station 48.

The inspection station 48 may include a machine-vision accept-reject sorter or be a manned inspection station in which shrimp with residual shell or appendages are sorted from the accepted peeled shrimp meats. The rejected shrimp with residual material are optionally returned to the system for reprocessing. A reprocessing path selector 50 directs the rejected shrimp back into the high-pressure press peeler 32 or to the hydraulic shell detacher 40 depending on the amount of residual material on each.

What is claimed is:

1. A system for processing shrimp comprising:
a hydraulic head detacher accelerating a flow of fluid carrying shrimp to subject the shrimp to turbulence detaching heads from the bodies of the shrimp;
a pressure chamber receiving the headless shrimp bodies from the hydraulic head detacher and subjecting the headless shrimp bodies to a hydrostatic pressure high enough and for a predetermined dwell time long enough to loosen the shells from the headless shrimp bodies without damaging the shrimp bodies.

2. A system as in claim 1 further comprising a head separator receiving the headless shrimp bodies and the detached heads from the hydraulic head detacher and separating the headless shrimp bodies from the detached heads.

3. A system as in claim 1 further comprising a hydraulic shell detacher accelerating a flow of fluid carrying loosened shell, appendages, and headless shrimp bodies received from the pressure chamber to subject the loosened shell, appendages, and headless shrimp bodies to turbulence detaching loosened shell and appendages from the headless shrimp bodies.

4. A system as in claim 3 further comprising a shell separator receiving the headless shrimp bodies from the hydraulic shell detacher and separating the detached shell and appendages from the shrimp bodies.

5. A system as in claim 3 further comprising an inspection station downstream of the hydraulic shell detacher receiving the shrimp bodies and redirecting shrimp bodies with residual shell or appendages back to the pressure chamber or the hydraulic shell detacher.

6. A system as in claim 5 wherein the inspection station includes a visioning system to inspect the shrimp bodies for residual shell and appendages.

7. A system as in claim 1 further comprising a first collector collecting the detached heads and shrimp bodies from the flow of water exiting the hydraulic head detacher.

8. A system as in claim 7 further comprising a second collector collecting the detached shell, appendages, and shrimp bodies from the flow of fluid exiting the hydraulic shell detacher.

9. A system as in claim 1 further comprising a water recirculation system treating the fluid exiting the hydraulic head detacher and recirculating the treated fluid back through the hydraulic head detacher.

10. A system as in claim 1 wherein the hydraulic head detacher comprises a flow restrictor causing an increase in the velocity of the flow.

11. A system as in claim 1 wherein the hydraulic head detacher comprises a series of venturis in cascade.

12. A system as in claim 1 wherein the hydraulic shell detacher comprises a flow restrictor causing an increase in the velocity of the flow.

13. A system as in claim 1 wherein the hydraulic shell detacher comprises a series of venturis in cascade.

14. A system as in claim 1 wherein the pressure chamber is a high-pressure food press.

15. A method for processing shrimp comprising:
(a) accelerating a flow of fluid carrying shrimp to subject the shrimp to turbulence detaching heads from the bodies of the shrimp;
(b) subjecting the headless shrimp bodies to a hydrostatic pressure high enough and for a dwell time long enough to loosen shell and appendages from the headless shrimp bodies without damaging the shrimp bodies;

16. The method of claim 15 further comprising:
(c) accelerating a flow of fluid carrying headless shrimp bodies with loosened shell to subject the headless shrimp bodies with loosened shell to turbulence that detaches the loosened shell from the headless shrimp bodies.

17. The method of claim 16 further comprising:
separating the headless shrimp bodies from the detached heads before subjecting the headless shrimp bodies to the hydrostatic pressure; and
separating the detached loosened shell from the headless shrimp bodies.

18. The method of claim 16 further comprising, after detaching the loosened shell and appendages, inspecting the headless shrimp bodies for residual shell and appendages and repeating step (c) on headless shrimp bodies having residual shell or appendages.

19. The method of claim 16 further comprising , after detaching the loosened shell and appendages, inspecting the headless shrimp bodies for residual shell and appendages and repeating steps (b) and (c) on headless shrimp bodies having residual shell or appendages.
